(19) United States
(12) Patent Application Publication
(10) Pub. No.: US 2025/0274247 A1
(43) Pub. Date: Aug. 28, 2025

(54) CHANNEL MEASUREMENT METHOD AND APPARATUS, AND STORAGE MEDIUM

(71) Applicant: Beijing Xiaomi Mobile Software Co., Ltd., Beijing (CN)

(72) Inventor: Qin MU, Beijing (CN)

(21) Appl. No.: 18/722,073

(22) PCT Filed: Dec. 22, 2021
(86) PCT No.: PCT/CN2021/140548

§ 371 Date: Jun. 20, 2024

(51) Int. Cl. H04L 5/00

(52) U.S. Cl. CPC H04L 5/0094; H04L 5/006

(57) ABSTRACT

A channel measurement method is applied to a terminal, and includes: in response to that a bandwidth part (BWP) monitored by the terminal is a first BWP and that channel measurement needs to be performed, performing the channel measurement based on a measurement strategy; wherein the first BWP carries at least one of following downlink information of the terminal: a system message, a paging message, or an initial access message.

### CROSS-REFERENCE TO RELATED APPLICATIONS

The present application is a U.S. National Stage of International Application No. PCT/CN2021/140548, filed on Dec. 22, 2021, the disclosure of which is incorporated herein by reference in its entirety.

### TECHNICAL FIELD

The present disclosure relates to the technical field of communications, and in particular to a channel measurement method and device and a storage medium.

### BACKGROUND

In related art, in a 5G New Radio system, an initial bandwidth part (BWP) is defined. The initial BWP includes an initial downlink bandwidth part (DL BWP) or an initial uplink bandwidth part (UL BWP).

In the NR system, when the terminal performs BWP monitoring, if the BWP that is being monitored currently (active BWP) is the initial DL BWP, and the terminal determines that it needs to perform measurements based on a Synchronization Signal and PBCH block (SSB), it can directly perform the measurements based on the SSB. That is, the terminal can monitor the initial DL BWP and perform the measurements based on the SSB at the same time.

In the current 3GPP standardization, it is proposed to design a new type of terminal to cover the requirements of midrange Internet of Thing (IoT) devices. This new type of terminal is called a low-capability terminal, sometimes also called Reduced capability UE, a Redcap terminal, or a NR-lite for short.

At present, the bandwidth capability of the RedCap terminal is relatively small, for example, the maximum bandwidth under FR2 is 100 MHz. Therefore, there may be the situation where the bandwidth for monitoring the initial DL BWP and performing the measurements based on the SSB exceed the bandwidth capability of the RedCap terminal, and it is impossible to monitor the initial DL BWP and perform the measurements based on the SSB at the same time.

### SUMMARY

According to a first aspect of the embodiments of the present disclosure, there is provided a channel measurement method applied to a terminal, the method including:

in response to that a BWP monitored by the terminal is a first BWP and that channel measurement needs to be performed, the channel measurement is performed based on a measurement strategy: where the first BWP carries at least one of the following downlink information of the terminal: a system message, a paging message, or an initial access message.

According to a second aspect of the embodiments of the present disclosure, there is provided a channel measurement method applied to a network device, the method including:

configuring a first BWP for a terminal, and configuring a measurement strategy for performing channel measurement for the terminal: where the first BWP is used to carry at least one of the following downlink information of the terminal: a system message, a paging message, or an initial access message.

According to a third aspect of the embodiments of the present disclosure, there is provided a channel measurement method applied to a network device, the method including:

configuring a first BWP for a terminal, the first BWP being used to carry at least one of the following downlink information of the terminal: a system message, a paging message or an initial access message: where a sum of a frequency domain bandwidth occupied by the first BWP and a frequency domain bandwidth occupied by a SSB is less than or equal to a maximum bandwidth supported by the terminal.

According to a fourth aspect of the embodiments of the present disclosure, there is provided a channel measurement device, including:

a processing unit configured to perform channel measurement based on a measurement strategy in response to determining that a BWP monitored by the terminal is a first BWP and that channel measurement needs to be performed; where the first BWP carries at least one of the following downlink information of the terminal: a system message, a paging message or an initial access message.

According to a fifth aspect of embodiments of the present disclosure, there is provided a channel measurement device, including:

a processing unit configured to configure a first BWP for a terminal, and configure a measurement strategy for performing channel measurement for the terminal: the first BWP being used to carry at least one of the following downlink information of the terminal: a system message, a paging message, or an initial access message.

According to a sixth aspect of embodiments of the present disclosure, there is provided a channel measurement device, including:

a processing unit configured to configure a first BWP for a terminal, where the first BWP is used to carry at least one of the following downlink information of the terminal: a system message, a paging message, or an initial access message:

a sum of a frequency domain bandwidth occupied by the first BWP and a frequency domain bandwidth occupied by a SSB is less than or equal to a maximum bandwidth supported by the terminal.

According to a seventh aspect of embodiments of the present disclosure, there is provided a channel measurement device, including:

a processor: and a memory for storing instructions executable by the processor:

where the processor is configured to perform the method according to the first aspect or any of the implementations of the first aspect.

According to an eighth aspect of embodiments of the present disclosure, there is provided a channel measurement device, including:

a processor; and a memory for storing instructions executable by the processor:

where the processor is configured to perform the method according to the second aspect or any of the implementations of the second aspect, or perform the method according to the third aspect.

According to a ninth aspect of the embodiments of the present disclosure, there is provided a non-transitory computer-readable storage medium, where when instructions in the storage medium are executed by a processor of a terminal, the terminal is caused to perform the method according to the first aspect or any of the implementations of the first aspect.

According to a tenth aspect of the embodiments of the present disclosure, there is provided a non-transitory computer-readable storage medium, where when instructions in the storage medium are executed by a processor of a network device, the network device is caused to perform the method according to the second aspect or any of the implementations of the second aspect, or perform the method according to the third aspect.

It is to be understood that the foregoing general description and the following detailed description are exemplary and explanatory only and cannot restrict the present disclosure.

### BRIEF DESCRIPTION OF THE DRAWINGS

The accompanying drawings, which are incorporated in and constitute a part of the specification, illustrate embodiments consistent with the present disclosure and together with the description serve to explain the principles of the present disclosure.

FIG. 1 is a schematic diagram of a wireless communication system according to an illustrative embodiment.

FIG. 2 shows a schematic diagram of time-division multiplexing of CORESET #0 and SSB based on pattern 1 provided in an illustrative embodiment of the present disclosure.

FIG. 3 shows a schematic diagram of frequency division multiplexing of CORESET #0 and SSB based on pattern 2 provided in an illustrative embodiment of the present disclosure.

FIG. 4 shows a schematic diagram of frequency division multiplexing of CORESET #0 and SSB based on pattern 3 provided in an illustrative embodiment of the present disclosure.

FIG. 5 is a flow chart showing a channel measurement method according to an illustrative embodiment.

FIG. 6 is a flow chart showing a channel measurement method according to an illustrative embodiment.

FIG. 7 is a flow chart showing a method for channel measurement according to an illustrative embodiment.

FIG. 8 is a flow chart showing a channel measurement method according to an illustrative embodiment.

FIG. 9 is a flow chart showing a channel measurement method according to an illustrative embodiment.

FIG. 10 is a flow chart showing a method for channel measurement according to an illustrative embodiment.

FIG. 11 is a flow chart showing a channel measurement method according to an illustrative embodiment.

FIG. 12 is a flow chart showing a channel measurement method according to an illustrative embodiment.

FIG. 13 is a flow chart showing a channel measurement method according to an illustrative embodiment.

FIG. 14 is a block diagram of a channel measurement device according to an illustrative embodiment.

FIG. 15 is a block diagram of a channel measurement device according to an illustrative embodiment.

FIG. 16 is a block diagram of a channel measurement device according to an illustrative embodiment.

FIG. 17 is a block diagram showing a device for channel measurement according to an illustrative embodiment.

FIG. 18 is a block diagram showing a device for channel measurement according to an illustrative embodiment.

### DETAILED DESCRIPTION

Reference will now be made in detail to the illustrative embodiments, examples of which are illustrated in the accompanying drawings. When the following description refers to the accompanying drawings, the same numerals in different drawings refer to the same or similar elements unless otherwise indicated. The implementations described in the following illustrative examples do not represent all implementations consistent with the present disclosure.

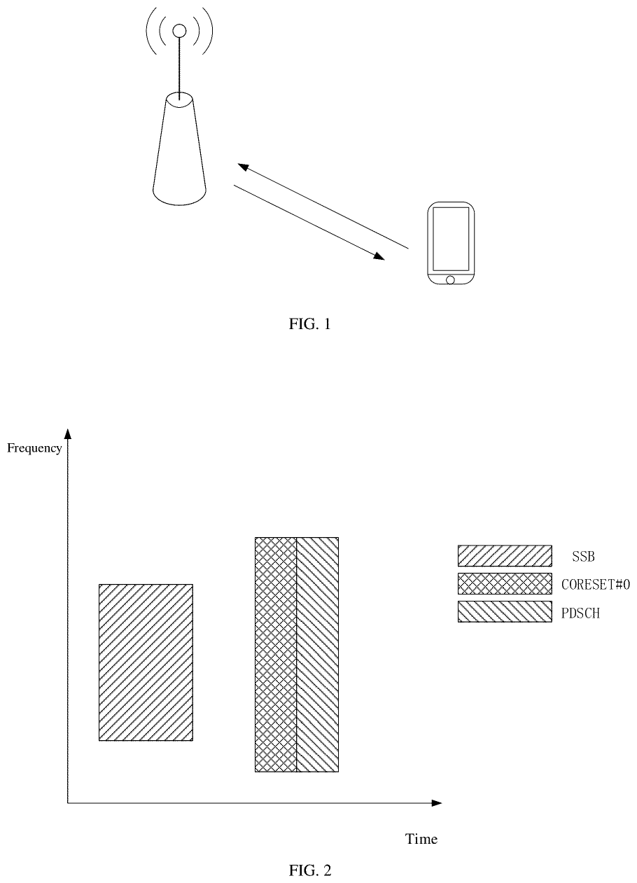

The channel measurement method provided by the embodiments of the present disclosure may be applied to a wireless communication system shown in FIG. 1. Referring to FIG. 1, the wireless communication system includes a terminal and a network device. Information is sent and received between the terminal and the network device through wireless resources.

It can be understood that the wireless communication system shown in FIG. 1 is only for schematic illustration, and the wireless communication system may also include other network devices, such as a core network device, a wireless relay device, and a wireless backhaul device, which are not shown in FIG. 1. The number of the network devices and the number of the terminals included in the wireless communication system are not limited in the embodiments of the present disclosure.

It can be further understood that the wireless communication system in the embodiments of the present disclosure is a network that provides wireless communication function. The wireless communication systems can use different communication technologies, such as code division multiple access (CDMA), wideband code division multiple access (WCDMA), time division multiple access (TDMA), frequency division multiple access (FDMA), orthogonal frequency division multiple access (OFDMA), single carrier frequency division multiple access (SC-FDMA), and Carrier Sense Multiple Access with Collision Avoidance. According to the capacity, speed, delay and other factors of different networks, the networks can be divided into 2th generation (2G) network, 3G network, 4G network or future evolved network, such as 5G network, and the 5G network can also be referred to as New Radio (NR). For convenience of description, sometimes the wireless communication network is simply referred to as a network in the present disclosure.

Further, the network device involved in the present disclosure may also be referred to as a wireless access network device. The wireless access network device may be a base station, an evolved base station (evolved node B), a home base station, an access point (AP) in a wireless fidelity (WI-FI) system, a wireless relay node, a wireless backhaul node, a transmission point (TP), a transmission and reception point (TRP), or the like, may also be a gNB in an NR system, or may also be a component or a part of a device constituting a base station. In a vehicle-to-everything (V2X) communication system, the network device may also be a vehicle-mounted device. It should be understood that in the embodiments of the present disclosure, there is no limitation on the specific technology and specific device form adopted by the network device.

Further, the terminal involved in the present disclosure, which may also be referred to as a terminal device, user equipment (UE), a mobile station (MS), a mobile terminal (MT), etc., is a device that provides voice and/or data connectivity to the user. For example, the terminal may be a handheld device with a wireless connection function, a vehicle-mounted device, or the like. At present, some examples of the terminal are a Mobile Phone, a Pocket Personal Computer (PPC), a palmtop computer, a Personal Digital Assistant (PDA), a notebook computer, a tablet computer, a wearable device, a vehicle-mounted device, etc. In addition, in a vehicle-to-everything (V2X) communication system, the terminal device may also be a vehicle-mounted device. It should be understood that in the embodiments of the present disclosure, there is no limitation on the specific technology and specific device form adopted by the terminal.

The terminal involved in the embodiments of the present disclosure can be understood as a new type of terminal designed in 5G NR, i.e., a low-capability terminal. The low-capability terminal is sometimes also called a Reduced capability UE or a Redcap terminal, or referred to as NR-lite for short. In the embodiments of the present disclosure, this new terminal is called a Redcap terminal.

Similar to Internet of Things (IoT) devices in Long Term Evolution (LTE), the 5G NR-lite generally needs to meet the following requirements:
low cost and low complexity;
coverage enhancement to some extent; and
power saving.

Since the current NR system is designed for high-end terminals such as those of high-speed and low-latency, the current design cannot meet the above requirements of the NR-lite. Therefore, it is necessary to modify the current NR system to meet the requirements of the NR-lite. For example, in order to meet the requirements of low cost and low complexity, a Radio Frequency (RF) bandwidth of the NR-IoT can be limited, such as limited to 5M Hz or 10M Hz, or a buffer size of the NR-lite can be limited so that a size of a transmission block received each time is limited, and so on. For power saving, a possible optimization manner is to simplify the communication process and reduce the number of times the NR-lite terminal detects the downlink control channel, etc.

In related art, in order to better support the terminals that cannot process the entire carrier bandwidth and for the purpose of receiving bandwidth adaption, the NR standard defines a BWP. In the NR system, an initial BWP is configured for the terminal in an idle/inactive state. When the terminal enters the inactive state from a connected state, it will need to monitor the initial BWP. In the 5G NR system, an initial DL BWP or an initial UL BWP is defined. In the 5G NR system, when BWP monitoring is performed for an ordinary terminal (not the Redcap terminal), if the BWP (active BWP) currently monitored by the terminal is the initial DL BWP and the ordinary terminal determines that it needs to perform SSB-based measurement, it can directly perform the SSB-based measurement. That is, the terminal can simultaneously monitor the downlink transmission on the initial DL BWP and perform the SSB-based measurement.

At present, when the terminal monitors the downlink transmission on the initial DL BWP, it needs to monitor the initial bandwidth of the downlink transmission, for example, monitor a control resource set (CORESET) #0. When the terminal simultaneously monitors the downlink transmission on the initial DL BWP and the SSB-based measurement, it may simultaneously monitor CORESET #0 and the SSB measurement. The CORESET #0 and SSB can be monitored in a time division multiplexing manner or a frequency division multiplexing manner. In related art, it supports to monitor CORESET #0 and the SSB-based measurement in the time division multiplexing manner of pattern 1, or the frequency division multiplexing manner of pattern 2 or pattern 3 can also be used to monitor CORESET #0 and the SSB-based measurement.

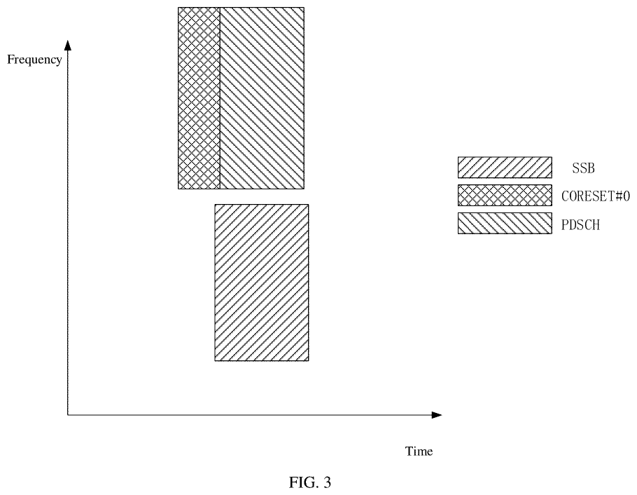

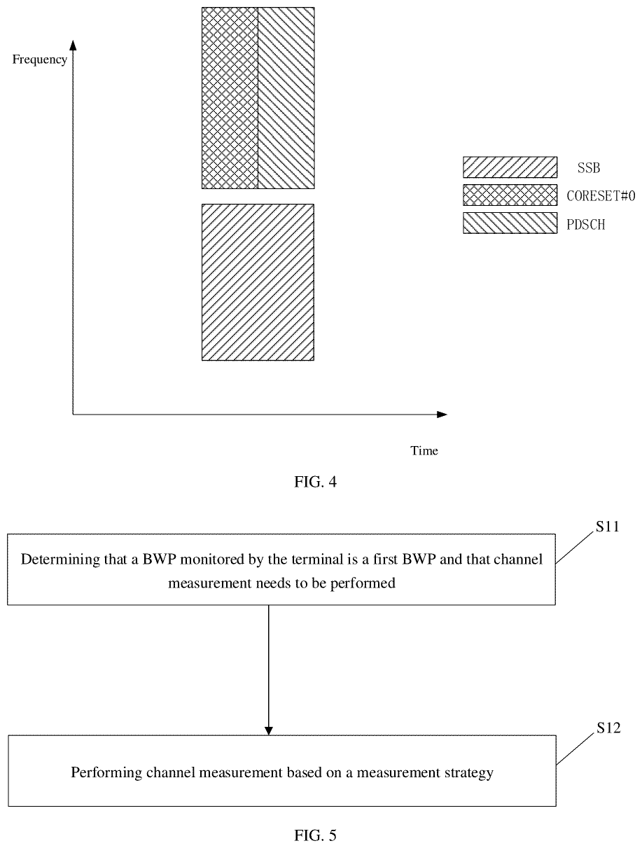

FIG. 2 shows a schematic diagram of time division multiplexing of CORESET #0 and SSB based on pattern 1 provided in an illustrative embodiment of the present disclosure. FIG. 3 shows a schematic diagram of frequency division multiplexing of CORESET #0 and SSB based on pattern 2 provided in an illustrative embodiment of the present disclosure. FIG. 4 shows a schematic diagram of frequency division multiplexing of CORESET #0 and SSB based on pattern 3 provided in an illustrative embodiment of the present disclosure.

In related arts, the initial DL BWP is determined by CORESET #0, and its bandwidth in the frequency domain is greater than or equal to the bandwidth of CORESET #0. For the RedCap terminal, the maximum bandwidth under FR2 is 100 MHz. In the case where the multiplexing manner of the SSB and CORESET #0 is multiplexing pattern 2 or 3, if the number of RBs is configured as 48, the number of symbols is configured as 1 and the offset is configured as 49, then the total bandwidth of the SSB and CORESET #0 is 128.16, which will exceed the RedCap's terminal bandwidth capability. If the number of RBs is configured as 48, the number of symbols is configured as 1, and the offset is configured as −42 corresponding to the case where the number of SSBs is greater than 0, then the total bandwidth of the SSB and CORESET #0 is 129.6, which will exceed the RedCap's terminal bandwidth capability. If the number of RBs is configured as 48, the number of symbols is configured as 1 and the offset is configured as-41 corresponding to the case where the number of SSBs is equal to 0, then the total bandwidth of the SSB and CORESET #0 is 128.16, which will exceed the RedCap's terminal bandwidth capability. That is, in the related art, for the RedCap terminal, there may be situations where it is impossible to monitor CORESET #0 and perform SSB-based measurement at the same time.

In view of this, in the embodiments of the present disclosure, there is provided a channel measurement method in which a measurement strategy for the terminal to perform channel measurement is determined for the situation where the terminal needs to perform channel measurement when monitoring the BWP carrying downlink information, so as to ensure that the terminal can normally complete the channel measurement, improving the communication effectiveness.

For the convenience of description, in the present disclosure, the BWP carrying downlink information involved in the present disclosure is referred to as a first BWP, and the downlink information carried by the first BWP includes at least one of the following: a system message, a paging information, or an initial access message. For example, the first BWP may be a BWP configured for an ordinary terminal in conventional technology, for example, an initial DL BWP corresponding to the ordinary terminal: the first BWP may also be a BWP including CORESET #0, or it may also be a BWP involved in the present disclosure that is newly configured for the terminal and is suitable for simultaneous SSB-based measurement.

FIG. 5 is a flowchart showing a channel measurement method according to an illustrative embodiment, and the method may be implemented separately or in combination with other embodiments of the present disclosure. As shown in FIG. 5, the channel measurement method is used in a terminal, and includes the following steps.

In step S11, it is determined that a BWP monitored by the terminal is a first BWP and that channel measurement needs to be performed.

The first BWP carries at least one of the following downlink information of the terminal: a system message, a paging message or an initial access message.

In step S12, the channel measurement is performed based on a measurement strategy.

In the present disclosure, determining that the BWP monitored by the terminal is the first BWP and that channel measurement needs to be performed may be understood as: determining that the terminal performs channel measurement on the first BWP monitored.

The measurement strategy involved in the present disclosure can be understood as strategy information for configuring the terminal to perform channel measurement, in order to perform communication coordination for the channel measurement in the case where the terminal monitors the first BWP and needs to perform the channel measurement, so that the terminal can accurately complete the monitoring of the first BWP and/or accurately perform the channel measurement.

In the channel measurement method provided in the present disclosure, when the terminal monitors the first BWP carrying the downlink information and needs to perform channel measurement, the channel measurement is performed based on the measurement strategy, so that the communication process of the channel measurement can be coordinated to realize coordinated communication and improve the effectiveness of the communications.

The implementation process for performing channel measurement based on the measurement strategy involved in the present disclosure below.

In an implementation of the present disclosure, the measurement strategy includes: performing SSB-based measurement based on a measurement gap configured by a network device. That is, when the active BWP of the terminal is the first BWP, the SSB-based measurement is performed within the measurement gap configured by the network device.

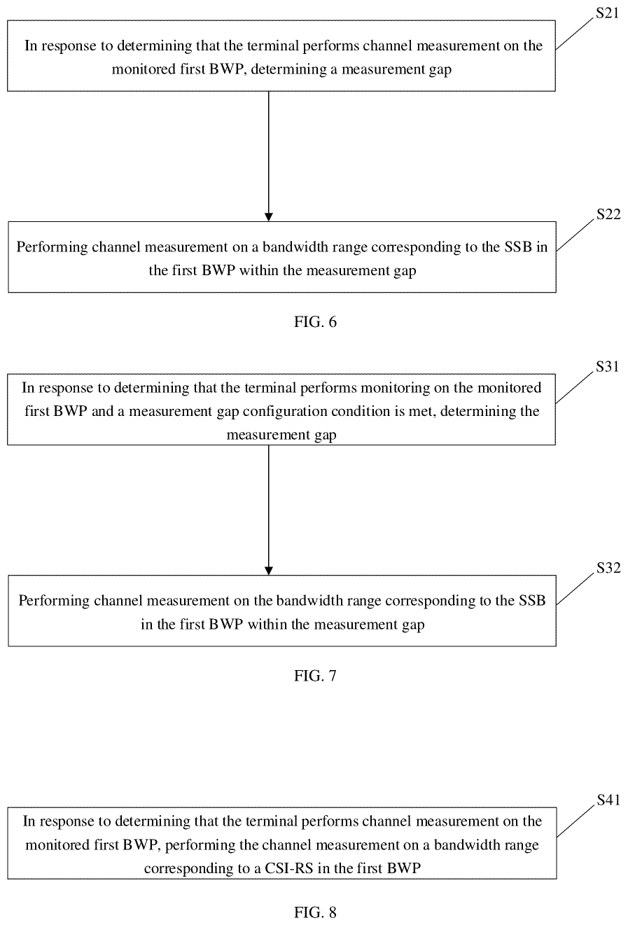

FIG. 6 is a flowchart showing a channel measurement method according to an illustrative embodiment, and the method may be implemented separately or in combination with other embodiments of the present disclosure. As shown in FIG. 6, the channel measurement method is used in a terminal, and includes the following steps.

In step S21, in response to determining that the terminal performs channel measurement on the monitored first BWP, a measurement gap is determined.

Within the measurement gap, the terminal performs the channel measurement on the bandwidth range corresponding to the SSB in the first BWP.

The first BWP carries at least one of the following downlink information of the terminal: a system message, a paging message or an initial access message.

In step S22, the channel measurement is performed on the bandwidth range corresponding to the SSB in the first BWP within the measurement gap.

In a typical implementation, performing the channel measurement on the bandwidth range corresponding to the SSB in the first BWP within the measurement gap is also referred to as performing SSB-based measurement.

In the present disclosure, the measurement gap for performing the SSB measurement is configured by the network device or determined according to communication standards. The terminal performs the SSB-based measurements within the measurement gap. In order to avoid that the total bandwidth for monitoring the first BWP and performing the SSB-based measurement exceeds the maximum bandwidth capability supported by the terminal, in the present disclosure, when the terminal performs the SSB-based measurement within the measurement gap, the terminal does not monitor at least the entire BWP of the first BWP. It can be understood that, in the present disclosure, if the total bandwidth for the terminal to monitor partial BWP in the first BWP and for the terminal to perform the SSB-based measurement is less than the maximum bandwidth capability supported by the terminal, the terminal can perform the SSB-based measurement and monitor partial BWP in the first BWP within the measurement gap. That is, the method may include in response to determining that the terminal monitors partial BWP of the first BWP and performs channel measurement on the first BWP, determining whether a sum of the bandwidth range of the partial BWP of the first BWP monitored by the terminal and the bandwidth range corresponding to the SSB measured by the terminal is greater than the maximum bandwidth capability supported by the terminal: and if so, stopping monitoring on the bandwidth range of the partial BWP, and performing channel measurement on the bandwidth range corresponding to the SSB.

In the embodiment of the present disclosure, the measurement gap may be a time range, and the terminal performs channel measurement on the bandwidth range corresponding to the SSB within this time range. In some possible implementations, for example, for the multiplexing pattern 2 as shown in FIG. 3 and multiplexing pattern 3 as shown in FIG. 4, the SSB and CORESET #0 in the BWP are frequency division multiplexed, and the frequency range of the SSB and CORESET #0 may exceed the maximum bandwidth range supported by the terminal. In this scenario, the terminal performs channel measurement only for a part of the bandwidth range, for example, the terminal performs channel measurement only for the bandwidth range corresponding to the SSB.

In the present disclosure, the network device can configure the measurement gap for the terminal for performing the SSB-based measurement in the scenario where it is determined that a measurement gap configuration condition is met. When determining that the measurement gap configuration condition is met, the terminal performs the SSB-based measurement within the measurement gap.

FIG. 7 is a flowchart showing a channel measurement method according to an illustrative embodiment, and the method may be implemented separately or in combination with other embodiments of the present disclosure. As shown in FIG. 7, the channel measurement method is used in the terminal, and includes the following steps.

In step S31, in response to determining that the terminal performs monitoring on the monitored first BWP and a measurement gap configuration condition is met, the measurement gap is determined.

Within the measurement gap, the terminal performs channel measurement on the bandwidth range corresponding to the SSB in the first BWP.

The first BWP carries at least one of the following downlink information of the terminal: a system message, a paging message or an initial access message.

In a typical implementation, performing the channel measurement performed on the bandwidth range corresponding to the SSB in the first BWP within the measurement gap is also referred to as performing SSB-based measurement.

In an implementation, the terminal determines the measurement gap in a scenario where the measurement gap configuration condition is met. For example, the scenario where the measurement gap configuration condition is met includes at least one of the following:

an operating frequency band of the terminal is frequency band 2;

CORESET #0 and SSB in the first BWP are frequency division multiplexed in pattern 2 or pattern 3; or

a sum of a frequency domain bandwidth occupied by CORESET #0 and a frequency domain bandwidth occupied by the SSB in the first BWP is greater than the maximum bandwidth supported by the terminal.

In step S32, the channel measurement is performed on the bandwidth range corresponding to the SSB in the first BWP within the measurement gap.

In a typical implementation, performing the channel measurement on the bandwidth range corresponding to the SSB in the first BWP within the measurement gap is also referred to as SSB-based measurement.

In the present disclosure, in a case where the measurement gap configuration condition is met and it is determined that the terminal performs channel measurement on the monitored first BWP, the SSB-based measurement is performed within the measurement gap, so that performing the SSB-based measurement in the first BWP can be realized.

In an example, in a case where the first BWP is the initial DL BWP, the operating frequency band of the terminal is frequency band 2, CORESET #0 and SSB are frequency division multiplexed in pattern 2 or pattern 3, and the sum of the frequency domain bandwidth occupied by CORESET #0 and the frequency domain bandwidth occupied by the SSB is greater than the maximum bandwidth supported by the terminal, the terminal can perform the SSB-based measurement within the measurement gap, and at least not monitor the initial DL BWP within the measurement gap, so that coordinated communication for the SSB measurement can be realized.

In another implementation of the present disclosure, the measurement strategy includes: not supporting the SSB-based measurement, and performing channel measurement on a bandwidth range corresponding to a Channel State Information (CSI)-Reference Signal (RS) in the first BWP.

FIG. 8 is a flowchart showing a channel measurement method according to an illustrative embodiment, and the method may be implemented separately or in combination with other embodiments of the present disclosure. As shown in FIG. 8, the channel measurement method is used in the terminal, and includes the following steps.

In step S41, in response to determining that the terminal performs channel measurement on the monitored first BWP, the channel measurement is performed on a bandwidth range corresponding to a CSI-RS in the first BWP.

The first BWP carries at least one of the following downlink information of the terminal: a system message, a paging message or an initial access message.

Performing the channel measurement on the bandwidth range corresponding to the CSI-RS can also be understood as performing CSI-RS-based measurement.

In the present disclosure, the terminal monitors the first BWP, and can perform the CSI-RS-based measurement when the channel measurement is required. In some implementations, the network device may not configure the SSB-based measurement for the terminal, and may configure the CSI-RS-based measurement. In this case, the terminal does not perform the SSB-based measurement, and performs the CSI-RS-based measurement in the first BWP. Since the frequency domain bandwidth occupied by the CSI-RS is smaller than the first BWP, it can be guaranteed that the channel measurement is performed normally.

In an implementation of the present disclosure, the measurement strategy of not supporting the SSB-based measurement can be configured when a preset condition is met. The preset condition includes at least one of the following:

an operating frequency band of the terminal is frequency band 2;

control resource set 0 and SSB in the first BWP are frequency division multiplexed in pattern 2 or pattern 3; or

a sum of a frequency domain bandwidth occupied by the control resource set 0 and a frequency domain bandwidth occupied by the SSB in the first BWP is greater than the maximum bandwidth supported by the terminal.

In an example of the present disclosure, in a case where the first BWP is the initial DL BWP, the operating frequency band of the terminal is frequency band 2, CORESET #0 and SSB are frequency division multiplexed in pattern 2 or pattern 3, and the sum of the frequency domain bandwidth occupied by CORESET #0 and the frequency domain bandwidth occupied by the SSB is greater than the maximum bandwidth supported by the terminal, the terminal can perform the CSI-RS-based channel measurement, and can realize simultaneously monitoring CORESET #0 and performing the CSI-RS-based channel measurement.

In another implementation of the present disclosure, a BWP may be configured for the terminal as the first BWP of the terminal, and the sum of the frequency domain bandwidth occupied by the first BWP and the frequency domain bandwidth occupied by the SSB is less than or equal to the maximum bandwidth supported by the terminal, so as to satisfy that the terminal monitors the BWP and performs the SSB-based measurement at the same time. For other BWPs in the present disclosure, the occupied frequency domain bandwidths occupied by the other BWPs are different from the frequency domain bandwidth occupied by the first BWP, or the time domain positions of the other BWPs are different from the time domain position of the first BWP.

In yet another implementation of the present disclosure, the measurement strategy includes configuring a first BWP for the terminal that can be used for simultaneously performing BWP monitoring and SSB-based measurement, and performing the SSB-based measurement in the configured first BWP.

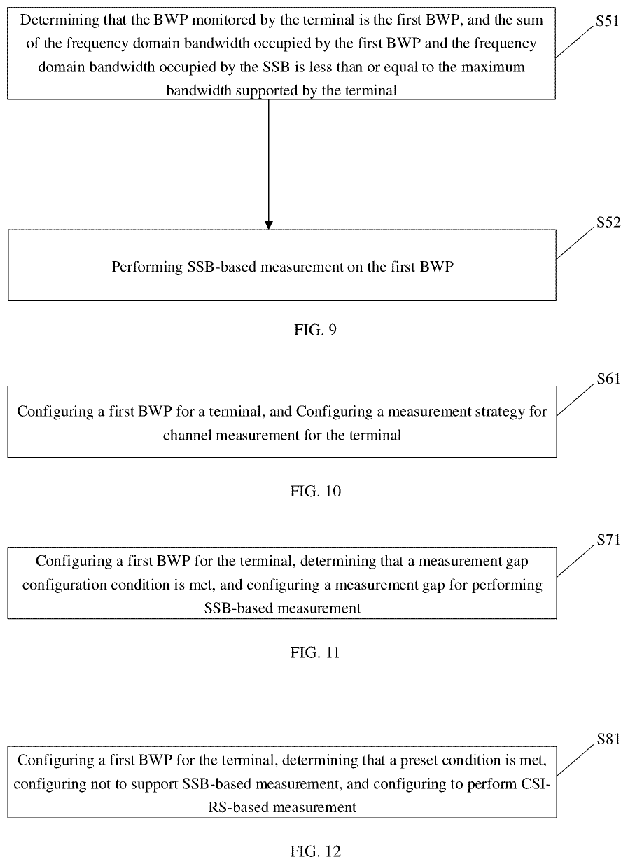

FIG. 9 is a flow chart showing a channel measurement method according to an illustrative embodiment, and the method may be implemented separately or in combination with other embodiments of the present disclosure. As shown in FIG. 9, the channel measurement method is used in the terminal, and includes the following steps.

In step S51, it is determined that the BWP monitored by the terminal is the first BWP, and the sum of the frequency domain bandwidth occupied by the first BWP and the frequency domain bandwidth occupied by the SSB is less than or equal to the maximum bandwidth supported by the terminal.

In step S52, SSB-based measurement is performed on the first BWP.

In the present disclosure, the first BWP can be understood as a BWP for carrying downlink information. For example, the first BWP is used to carry at least one of the following downlink information: a system message, a paging message or an initial access message. The first BWP is different from the initial DL BWP configured for the terminal in the conventional technology. In the present disclosure, for the convenience of description, the initial DL BWP configured for the terminal in the conventional technology is referred to as a second BWP.

In the present disclosure, the first BWP is different from the second BWP at least in bandwidth or location. The total bandwidth of the frequency domain bandwidth occupied by the first BWP and occupied by the SSB is less than or equal to the maximum bandwidth supported by the terminal. The terminal can simultaneously monitor CORESET #0 and perform SSB-based channel measurement on the first BWP.

In an implementation of the present disclosure, in response to determining that the preset condition is met, the first BWP is configured for the terminal. The preset condition includes at least one of the following: the operating frequency band of the terminal is frequency band 2: the control resource set 0 and the SSB are frequency division multiplexed in pattern 2 or pattern 3: or the total bandwidth of the frequency domain bandwidth occupied by the control resource set 0 and the frequency domain bandwidth occupied by the SSB is greater than the maximum bandwidth supported by the terminal.

It can be understood that the terminal that performs the channel measurement method mentioned above in the present disclosure may be a Redcap terminal or an ordinary terminal (non-Redcap terminal).

According to the above channel measurement methods applied to the terminal provided by the present disclosure, when the terminal monitors the first BWP and determines that channel measurement is required, the terminal performs the channel measurement based on the measurement strategy, which can ensure that the terminal accurately completes the channel measurement and improves the effectiveness of communication.

Based on the same concept, the present disclosure also provides a channel measurement method performed by a network device.

FIG. 10 is a flow chart showing a channel measurement method according to an illustrative embodiment, and the method may be implemented separately or in combination with other embodiments of the present disclosure. As shown in FIG. 10, the channel measurement method is used in a network device, and includes the following steps.

In step S61, a first BWP is configured for a terminal, and a measurement strategy for channel measurement is configured for the terminal.

The first BWP is used to carry at least one of the following downlink information of the terminal: a system message, a paging message or an initial access message.

In an implementation, configuring the measurement strategy for the terminal to perform channel measurement may be to configure a measurement gap for performing SSB-based measurement.

FIG. 11 is a flowchart showing a channel measurement method according to an illustrative embodiment, and the method may be implemented separately or in combination with other embodiments of the present disclosure. As shown in FIG. 11, the channel measurement method is used in a network device, and includes the following steps.

In step S71, a first BWP is configured for the terminal, it is determined that a measurement gap configuration condition is met, and a measurement gap for performing SSB-based measurement is configured.

In the present disclosure, the network device may configure the measurement gap for performing the SSB-based measurement in a case where it is determined that the measurement gap configuration condition is met. The measurement gap configuration condition being met includes at least one of the following:

an operating frequency band of the terminal is frequency band 2; the control resource set 0 and SSB in the first BWP are frequency division multiplexed in pattern 2 or pattern 3; or the sum of the frequency domain bandwidth occupied by the control resource set 0 and the frequency domain bandwidth occupied by the SSB in the first BWP is greater than the maximum bandwidth supported by the terminal.

In another implementation, configuring the measurement strategy for the channel measurement for the terminal may be to configure not to support the SSB-based measurement, and configure to perform CSI-RS-based measurement.

FIG. 12 is a flow chart showing a channel measurement method according to an illustrative embodiment, and the method may be implemented separately or in combination with other embodiments of the present disclosure. As shown in FIG. 12, the channel measurement method is used in a network device, and includes the following steps.

In step S81, a first BWP is configured for the terminal, it is determined that a preset condition is met, it is configured not to support SSB-based measurement, and it is configured to perform CSI-RS-based measurement.

The network device may configure not to support the SSB-based measurement and configure to perform the CSI-RS-based measurement when it is determined that a preset condition is met. The preset condition includes at least one of the following: an operating frequency band of the terminal is frequency band 2; the control resource set 0 and the SSB in the first BWP are frequency division multiplexed in pattern 2 or pattern 3; or the sum of the frequency domain bandwidth occupied by the control resource set 0 and the frequency domain bandwidth occupied by the SSB in the first BWP is greater than the maximum bandwidth supported by the terminal.

In another implementation, configuring the measurement strategy for the channel measurement for the terminal may be to configure a second BWP for the terminal, so that the terminal performs the SSB-based measurement in the second BWP.

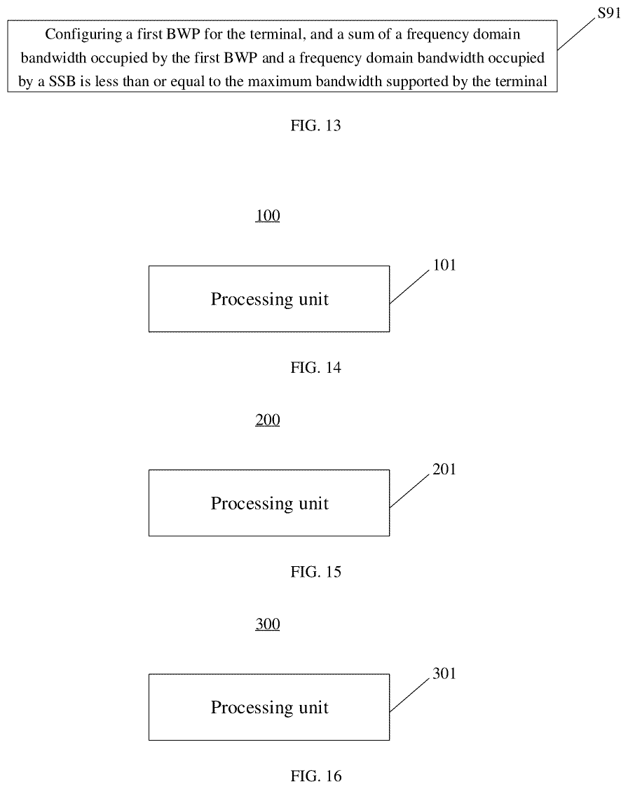

FIG. 13 is a flowchart showing a channel measurement method according to an illustrative embodiment, and the method may be implemented separately or in combination with other embodiments of the present disclosure. As shown in FIG. 13, the channel measurement method is used in a network device, and includes the following steps.

In step S91, a first BWP is configured for the terminal, and a sum of a frequency domain bandwidth occupied by the first BWP and a frequency domain bandwidth occupied by a SSB is less than or equal to the maximum bandwidth supported by the terminal.

In the present disclosure, the first BWP is different from the second BWP at least in bandwidth or location. The total bandwidth of the frequency domain bandwidth occupied by the first BWP and the frequency domain bandwidth occupied by the SSB is less than or equal to the maximum bandwidth supported by the terminal. The terminal can simultaneously monitor CORESET #0 and perform SSB-based channel measurement on the first BWP.

In an implementation of the present disclosure, in response to determining that the preset condition is met, the first BWP is configured for the terminal. The preset condition includes at least one of the following: the operating frequency band of the terminal is frequency band 2; the control resource set 0 and the SSB are frequency division multiplexed in pattern 2 or pattern 3; or the sum of the frequency domain bandwidth occupied by the control resource set 0 and the frequency domain bandwidth occupied by the SSB is greater than the maximum bandwidth supported by the terminal.

In the channel measurement methods provided in the present disclosure, the network device configures the measurement strategy for the terminal to perform channel measurement, or configures the first BWP that is suitable for simultaneously performing BWP monitoring and SSB measurement, so that the terminal performs channel measurement on the monitored first BWP, which can ensure that the terminal accurately completes the channel measurement and improves the effectiveness of communication.

It can be understood that the channel measurement methods performed by the network device in the embodiments of the present disclosure correspond to the channel measurement methods performed by the terminal in the above embodiments, and for the details on the channel measurement methods performed by the network device, reference can be made to the above channel measurement methods performed by the terminal, which will not be described in detail here.

It can be further understood that the channel measurement methods provided by the embodiments of the present disclosure may be applicable to scenarios where a terminal interacts with a network device to implement channel measurement. For the functions realized by the terminal and the network device involved in the specific implementation process, reference can be made to the relevant description involved in the above embodiments, which will not be described in detail here.

It should be noted that those skilled in the art can understand that the various implementations/embodiments mentioned above in the embodiments of the present disclosure can be used in conjunction with the foregoing embodiments, or can be used independently. Whether it is used separated or in conjunction with the foregoing embodiments, the implementation principles are similar. In the implementations of the present disclosure, some of the embodiments are described in the manner of being used together. Of course, those skilled in the art can understand that such illustrations are not limitations on the embodiments of the present disclosure.

Based on the same concept, the embodiments of the present disclosure also provide a channel measurement device.

It can be understood that, in order to realize the above-mentioned functions, the channel measurement device provided by the embodiments of the present disclosure includes corresponding hardware structures and/or software modules for performing various functions. In combination with units and algorithm steps of the examples disclosed in the embodiments of the present disclosure, the embodiments of the present disclosure can be implemented in the form of hardware or a combination of hardware and computer software. Whether a certain function is executed by hardware or computer software driving hardware depends on the specific applications and design constraints of the technical solution. Those skilled in the art may use different methods to implement the described functions for each specific application, and such implementations should not be regarded as going beyond the scope of the technical solutions of the embodiments of the present disclosure.

FIG. 14 is a block diagram of a channel measurement device according to an illustrative embodiment. Referring to FIG. 14, the channel measurement device 100 can be provided as a terminal, and includes a processing unit 101.

The processing unit 101 is configured to perform channel measurement based on a measurement strategy in a case where it is determined that a BWP monitored by the terminal is a first BWP and that the channel measurement needs to be performed: where the first BWP carries at least one of the following downlink information of the terminal: a system message, a paging messages or an initial access message.

In an implementation, the measurement strategy includes: performing SSB-based measurement based on a measurement gap configured by a network device: and the processing unit 101 is configured to perform the SSB-based measurement within the measurement gap.

In an implementation, in response to determining that a measurement gap configuration condition is met, the processing unit 101 is configured to perform the SSB-based measurement within the measurement gap.

In an implementation, the measurement gap configuration condition being met includes at least one of the following:

an operating frequency band of the terminal is frequency band 2; a control resource set 0 and SSB in the first BWP are frequency division multiplexed in pattern 2 or pattern 3; or a sum of a frequency domain bandwidth occupied by the control resource set 0 and a frequency domain bandwidth occupied by the SSB in the first BWP is greater than the maximum bandwidth supported by the terminal.

In an implementation, the measurement strategy includes: not supporting the SSB-based measurement and allowing the network device to configure CSI-RS-based measurement, and the processing unit 101 is configured to perform the CSI-RS-based measurement in the first BWP.

In an implementation, the measurement strategy includes not supporting the SSB-based measurement when a preset condition is met.

The preset condition includes at least one of the following: the operating frequency band of the terminal is frequency band 2; the control resource set 0 and the SSB in the first BWP are frequency division multiplexed in pattern 2 or pattern 3; or the sum of the frequency domain bandwidth occupied by the control resource set 0 and the frequency domain bandwidth occupied by SSB in the first BWP is greater than the maximum bandwidth supported by the terminal.

In an implementation, the processing unit 101 is configured to perform the SSB-based measurement on the first BWP. The sum of the frequency domain bandwidth occupied by the first BWP and the frequency domain bandwidth occupied by the SSB is less than or equal to the maximum bandwidth supported by the terminal.

FIG. 15 is a block diagram of a channel measurement device according to an illustrative embodiment. Referring to FIG. 15, the channel measurement device 200 may be provided as a network device, and includes a processing unit 201.

The processing unit 201 is configured to configure a first BWP for a terminal, and configure a measurement strategy for the terminal to perform channel measurement: the first BWP is used to carry at least one of the following downlink information of the terminal: a system message, a paging message, or an initial access message.

In an implementation, the processing unit 201 is configured to configure a measurement gap for performing the SSB measurement.

In an implementation, in response to determining that a measurement gap configuration condition is met, the processing unit 201 is configured to configure the measurement gap for performing the SSB-based measurement.

In an implementation, the measurement gap configuration condition being met includes at least one of the following:

an operating frequency band of the terminal is frequency band 2; a control resource set 0 and SSB in the first BWP are frequency division multiplexed in pattern 2 or pattern 3; or a sum of a frequency domain bandwidth occupied by the control resource set 0 and a frequency domain bandwidth occupied by the SSB in the first BWP is greater than the maximum bandwidth supported by the terminal.

In an implementation, the processing unit 201 is configured to: configure to not support the SSB-based measurement, and configure to perform CSI-RS-based measurement.

In an implementation, when it is determined that a preset condition is met, the processing unit 201 is configured to: configure not to support the SSB-based measurement, and configure to perform CSI-RS-based measurement: the preset condition includes at least one of the following: an operating frequency band of the terminal is frequency band 2; the control resource set 0 and SSB in the first BWP are frequency division multiplexed in pattern 2 or pattern 3; or a sum of the frequency domain bandwidth occupied by the control resource set 0 and the frequency domain bandwidth occupied by the SSB in the first BWP is greater than the maximum bandwidth supported by the terminal.

FIG. 16 is a block diagram of a channel measurement device according to an illustrative embodiment. Referring to FIG. 16, the channel measurement apparatus 300 may be provided as a network device, and includes a processing unit 301.

The processing unit 301 is configured to configure a first BWP for a terminal, a sum of a frequency domain bandwidth occupied by the first BWP and a frequency domain bandwidth occupied by a SSB is less than or equal to the maximum bandwidth supported by the terminal; and the first BWP carries at least one of the following downlink information of the terminal; a system message, a paging message or an initial access message. Regarding the devices in the above embodiments, the specific manner in which the modules perform operations has been described in detail in the embodiments of the relevant methods, which will not be described in detail here.

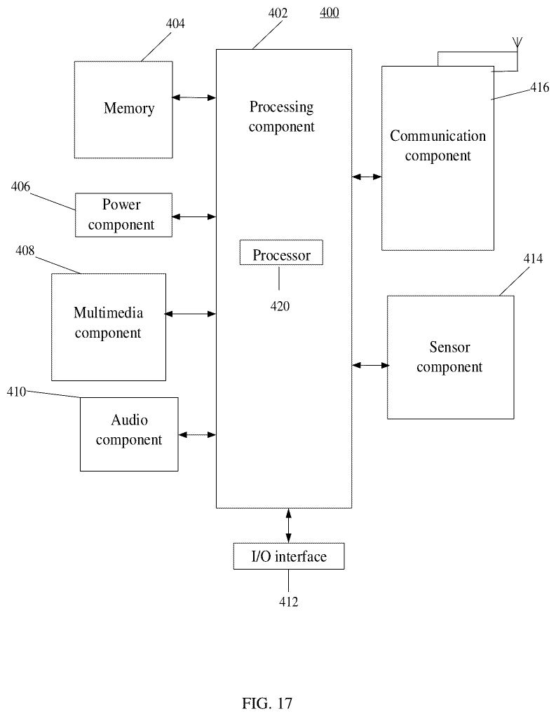

FIG. 17 is a block diagram showing a device 400 for channel measurement according to an illustrative embodiment. For example, the device 400 may be provided as the terminal involved in the foregoing embodiments. For example, the device 400 may be a mobile phone, a computer, a digital broadcast terminal, a messaging device, a game console, a tablet device, a medical device, a fitness device, a personal digital assistant, and the like.

Referring to FIG. 17, the device 400 may include one or more of the following components: a processing component 402, a memory 404, a power component 406, a multimedia component 408, an audio component 410, an input/output (I/O) interface 412, a sensor component 414, and a communication component 416.

The processing component 402 generally controls the overall operations of the device 400, such as operations associated with display, phone calls, data communications, camera operations, and recording operations. The processing component 402 may include one or more processors 420 to execute instructions to complete all or part of the steps of the above methods. Additionally, processing component 402 may include one or more modules that facilitate interaction between the processing component 402 and other components. For example, the processing component 402 may include a multimedia module to facilitate interaction between the multimedia component 408 and the processing component 402.

The memory 404 is configured to store various types of data to support operations at the device 400. Examples of such data include instructions for any application or method operating on the device 400, contact data, phonebook data, messages, pictures, videos, and the like. The memory 404 may be implemented by any type of volatile or non-volatile storage device or a combination thereof, such as a static random access memory (SRAM), an electrically erasable programmable read-only memory (EEPROM), an erasable Programmable read-only memory (EPROM), a programmable read-only memory (PROM), a read-only memory (ROM), a magnetic memory, a flash memory, a magnetic disk or an optical disk.

The power component 406 provides power to various components of the device 400. The power components 406 may include a power management system, one or more power supplies, and other components associated with generating, managing, and distributing power for the device 400.

The multimedia component 408 includes a screen that provides an output interface between the device 400 and the user. In some embodiments, the screen may include a liquid crystal display (LCD) and a touch panel (TP). If the screen includes a touch panel, the screen may be implemented as a touch screen to receive input signals from the user. The touch panel includes one or more touch sensors to sense touches, swipes, and gestures on the touch panel. The touch sensor may not only sense a boundary of a touch or slide action, but also detect duration and pressure associated with the touch or slide operation. In some embodiments, the multimedia component 408 includes a front camera and/or a rear camera. When the device 400 is in an operation mode, such as a shooting mode or a video mode, the front camera and/or the rear camera can receive external multimedia data. Each of the front camera and rear camera can be a fixed optical lens system or have a focal length and optical zoom capability.

The audio component 410 is configured to output and/or input audio signals. For example, the audio component 410 includes a microphone (MIC), which is configured to receive an external audio signal when the device 400 is in an operation mode, such as a call mode, a recording mode, and a voice recognition mode. The received audio signals may be further stored in memory 404 or sent via communication component 416. In some embodiments, the audio component 410 also includes a speaker for outputting audio signals.

The I/O interface 412 provides an interface between the processing component 402 and a peripheral interface module. The peripheral interface module may be a keyboard, a click wheel, a button, and the like. These buttons may include, but are not limited to, a home button, a volume button, a start button, and a lock button.

The sensor component 414 includes one or more sensors for providing status assessments of various aspects of the device 400. For example, the sensor component 414 can detect an open/closed state of the device 400, the relative positioning of components, such as the display and keypad of the device 400, and the sensor component 414 can also detect a change in the position of the device 400 or a component of the device 400, the presence or absence of user contact with the device 400, the orientation or acceleration/deceleration of the device 400 and temperature changes of the device 400. The sensor component 414 may include a proximity sensor configured to detect the presence of a nearby object without any physical contact. The sensor component 414 may also include an optical sensor, such as a CMOS or CCD image sensor, for use in imaging applications. In some embodiments, the sensor component 414 may also include an acceleration sensor, a gyroscope sensor, a magnetic sensor, a pressure sensor or a temperature sensor.

The communication component 416 is configured to facilitate wired or wireless communication between the device 400 and other devices. The device 400 can access wireless networks based on communication standards, such as Wi-Fi, 2G or 4G, or a combination thereof. In an illustrative embodiment, the communication component 416 receives broadcast signals or broadcast related information from an external broadcast management system via a broadcast channel. In an illustrative embodiment, the communication component 416 also includes a near field communication (NFC) module to facilitate short-range communication. For example, the NFC module can be implemented based on Radio Frequency Identification (RFID) technology, Infrared Data Association (IrDA) technology, Ultra Wide Band (UWB) technology, Bluetooth (BT) technology and other technologies.

In an illustrative embodiment, the device 400 may be programmed by one or more application specific integrated circuits (ASICs), digital signal processors (DSPs), digital signal processing devices (DSPDs), programmable logic devices (PLDs), field programmable Gate arrays (FPGAs), controllers, microcontrollers, microprocessors or other electronic component implementations for performing the methods described above.

In an illustrative embodiment, there is also provided a storage medium including instructions, such as the memory 404 including instructions, and the instructions can be executed by the processor 420 of the device 400 to complete the above methods. For example, the non-transitory computer readable storage medium may be a ROM, a random access memory (RAM), a CD-ROM, a magnetic tape, a floppy disk, an optical data storage device, and the like.

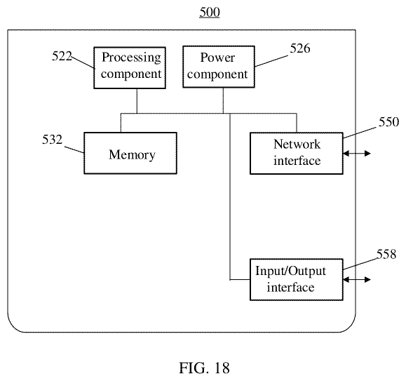

FIG. 18 is a block diagram showing a device 500 for channel measurement according to an illustrative embodiment. For example, the device 400 may be provided as a network device. Referring to FIG. 18, the device 500 includes a processing component 522, which further includes one or more processors, and memory resources represented by a memory 532 for storing instructions executable by the processing component 522, such as an application program. The application program stored in the memory 532 may include one or more modules each corresponding to a set of instructions. In addition, the processing component 522 is configured to execute instructions to perform the above methods.

The device 500 may also include a power component 526 configured to perform power management of the device 500, a wired or wireless network interface 550 configured to connect the device 500 to a network, and an input output (I/O) interface 558. The device 500 can operate based on an operating system stored in the memory 532, such as Windows Server™, Mac OS X™, Unix™, Linux™, FreeBSD™ or the like.

In an illustrative embodiment, there is also provided a storage medium including instructions, such as a memory 532 including instructions, and the instructions can be executed by the processing component 522 of the device 500 to complete the above methods. For example, the non-transitory computer readable storage medium may be a ROM, a random access memory (RAM), a CD-ROM, a magnetic tape, a floppy disk, an optical data storage device, etc.

The technical solutions provided by the embodiments of the present disclosure may include the following beneficial effects. When the terminal needs to perform channel measurement on the first BWP being monitored, the terminal performs the channel measurement based on the measurement strategy, so that coordinated communication can be performed and the effectiveness of the communication is improved.

It can be further understood that “a plurality of” in the present disclosure refers to two or more, and other quantifiers are similar. “And/or” describes the relationship between associated objects, indicating that there can be three relationships. For example, A and/or B can represent that A exists alone, A and B exist simultaneously, and B exists alone. The character “/” generally indicates that the related objects are in an “or” relationship. The singular forms of “a”, “an” and “the” are intended to include the plural forms as well, unless the context clearly indicates otherwise.

It can be further understood that the terms “first”, “second”, etc. are used to describe various information, but the information should not be limited to these terms. These terms are used only to distinguish information of the same type from one another and do not imply a specific order or importance. Actually, expressions such as “first” and “second” can be used interchangeably. For example, without departing from the scope of the present disclosure, the first information may also be called second information, and similarly, the second information may also be called first information.

It can be further understood that although operations are described in a specific order in the drawings in the embodiments of the present disclosure, it should not be understood as requiring that these operations be performed in the specific order shown or in a serial order, or requiring that all operations shown be performed to obtain the desired result. In certain circumstances, multitasking and parallel processing may be advantageous.

Other embodiments of the present disclosure will be readily apparent to those skilled in the art after consideration of the specification and practice of the present disclosure disclosed herein. The present disclosure is intended to cover any variations, uses, or adaptations of the present disclosure that follow the general principles of the present disclosure and include common knowledge or conventional technical means in the technical field that are not disclosed in the present disclosure.

It should be understood that the present disclosure is not limited to the precise constructions which have been described above and shown in the accompanying drawings, and various modifications and changes may be made without departing from the scope thereof. The scope of the present disclosure is limited only by the scope of the appended claims.

1. A channel measurement method, applied to a terminal, the method comprising:
in response to that a bandwidth part (BWP) monitored by the terminal is a first BWP and that channel measurement needs to be performed, performing the channel measurement based on a measurement strategy;
wherein the first BWP carries at least one of following downlink information of the terminal: a system message, a paging message, or an initial access message.

2. The method according to claim 1, wherein the measurement strategy comprises: performing Synchronization Signal and PBCH block (SSB)-based measurement based on a measurement gap configured by a network device;
wherein performing the channel measurement based on the measurement strategy comprises:
performing the SSB-based measurement within the measurement gap.

3. The method according to claim 2, wherein performing the SSB-based measurement within the measurement gap comprises:
in response to determining that a measurement gap configuration condition is met, performing the SSB-based measurement within the measurement gap.

4. The method according to claim 3, wherein the measurement gap configuration condition being met comprises at least one of:
an operating frequency band of the terminal is frequency band 2;
a control resource set 0 and a SSB in the first BWP are frequency division multiplexed in pattern 2 or pattern 3; or
a sum of a frequency domain bandwidth occupied by the control resource set 0 and a frequency domain bandwidth occupied by the SSB in the first BWP is greater than a maximum bandwidth supported by the terminal.

5. The method according to claim 1, wherein the measurement strategy comprises: not supporting SSB-based measurement, and allowing a network device to configure Channel State Information (CSI)-Reference Signal (RS)-based measurement, and
wherein performing the channel measurement based on the measurement strategy comprises:
performing the CSI-RS-based measurement within the first BWP.

6. The method according to claim 5, wherein the measurement strategy comprises: not supporting the SSB-based measurement in a case where a preset condition is met, and
wherein the preset condition comprises at least one of the following:
an operating frequency band of the terminal is frequency band 2;
a control resource set 0 and a SSB in the first BWP are frequency division multiplexed in pattern 2 or pattern 3; or
a sum of a frequency domain bandwidth occupied by the control resource set 0 and a frequency domain bandwidth occupied by the SSB in the first BWP is greater than a maximum bandwidth supported by the terminal.

7. The method according to claim 1, wherein performing the channel measurement based on the measurement strategy comprises:
performing SSB-based measurement on the first BWP, and
wherein a sum of a frequency domain bandwidth occupied by the first BWP and a frequency domain bandwidth occupied by the SSB is less than or equal to a maximum bandwidth supported by the terminal.

8. A channel measurement method, applied to a network device, the method comprising:
configuring a first bandwidth part (BWP) for a terminal, and configuring a measurement strategy for performing channel measurement for the terminal;
wherein the first BWP is used to carry at least one of following downlink information of the terminal: a system message, a paging message or an initial access message.

9. The method according to claim 8, wherein configuring the measurement strategy for performing channel measurement for the terminal comprises:
configuring a measurement gap for performing Synchronization Signal and PBCH block (SSB)-based measurement.

10. The method according to claim 9, wherein configuring the measurement gap for performing the SSB-based measurement comprises:
in response to determining that a measurement gap configuration condition is met, configuring the measurement gap for performing the SSB-based measurement.

11. The method according to claim 10, wherein the measurement gap configuration condition being met comprises at least one of:
an operating frequency band of the terminal is frequency band 2;
a control resource set 0 and SSB in the first BWP are frequency division multiplexed in pattern 2 or pattern 3; or
a sum of a frequency domain bandwidth occupied by the control resource set 0 and a frequency domain bandwidth occupied by the SSB in the first BWP is greater than a maximum bandwidth supported by the terminal.

12. The method according to claim 8, wherein configuring the measurement strategy for performing the channel measurement for the terminal comprises:
configuring not to support SSB-based measurement and configuring to perform Channel State Information (CSI)-Reference Signal (RS)-based measurement.

13. The method according to claim 12, wherein configuring not to support the SSB-based measurement and configuring to perform the CSI-RS-based measurement comprises:
in response to determining that a preset condition is met, configuring not to support the SSB-based measurement and configuring to perform the CSI-RS-based measurement, and
wherein the preset condition comprises at least one of the following:
an operating frequency band of the terminal is frequency band 2;
a control resource set 0 and SSB in the first BWP are frequency division multiplexed in pattern 2 or pattern 3;
a sum of a frequency domain bandwidth occupied by the control resource set 0 and a frequency domain bandwidth occupied by the SSB in the first BWP is greater than a maximum bandwidth supported by the terminal.

14. A channel measurement method, applied to a network device, the method comprising:
configuring a first bandwidth part (BWP) for a terminal, wherein the first BWP is used to carry at least one of the following downlink information of the terminal: a system message, a paging message, or an initial access message,
wherein a sum of a frequency domain bandwidth occupied by the first BWP and a frequency domain bandwidth occupied by a Synchronization Signal and PBCH block (SSB) is less than or equal to a maximum bandwidth supported by the terminal.

15.-20. (canceled)

21. A channel measurement device, comprising:
a processor; and
a memory for storing instructions executable by the processor;
wherein the processor is configured to perform the method according to claim 1.

22. A channel measurement device, comprising:
a processor; and
a memory for storing instructions executable by the processor;
wherein the processor is configured to perform the method according to claim 8.

23. (canceled)

24. (canceled)

25. A channel measurement device, comprising:
a processor; and
a memory for storing instructions executable by the processor;
wherein the processor is configured to perform the method according to claim 14.
